(19) United States
(12) Patent Application Publication
(10) Pub. No.: US 2018/0123760 A1
(43) Pub. Date: May 3, 2018

(54) Method and Apparatus for Transmitting Demodulation Reference Signals and System

(71) Applicant: FUJITSU LIMITED, Kawasaki-shi (JP)

(72) Inventors: Fan YANG, Beijing (CN); Hua ZHOU, Beijing (CN); Jianming WU, Beijing (CN)

(73) Assignee: FUJITSU LIMITED, Kawasaki-shi (JP)

(21) Appl. No.: 15/857,411

(22) Filed: Dec. 28, 2017

Related U.S. Application Data
(63) Continuation of application No. PCT/CN2015/083795, filed on Jul. 10, 2015.

(51) Int. Cl. H04L 5/00; H04W 72/04; H04L 25/02

(52) U.S. Cl. CPC H04L 5/0051; H04W 72/042; H04L 25/0228; H04W 72/0446; H04L 5/0007; H04L 5/0053; H04L 5/0094

(57) ABSTRACT

Embodiments of this disclosure provide a method and an apparatus for transmitting demodulation reference signals and a system. In an embodiment, the method is applicable to a long term evolution (LTE) communication system, the LTE communication system including first equipment and second equipment, the first equipment and the second equipment communicating via a sidelink, and the method includes: the first equipment transmits additional demodulation reference signals (DMRSs) to the second equipment via the sidelink, the additional DMRSs being located in the last orthogonal frequency division multiplexing (OFDM) symbol of each subframe of the sidelink. With the embodiments of this disclosure, new DMRS sequences are proposed and are placed in the last symbol of a subframe of the sidelink of the LTE system for transmission, thereby enhancing original DMRSs, and improving accuracy of channel estimation.

### CROSS REFERENCE TO RELATED APPLICATIONS

This application is a continuation application of International Application PCT/CN2015/083795 filed on Jul. 10, 2015, the entire contents of which are incorporated herein by reference.

### FIELD

This disclosure relates to the field of communication technologies, and in particular to a method and apparatus for transmitting demodulation reference signals and a system.

### BACKGROUND

A vehicle to X (V2X) service in a long term evolution (LTE) network employs existing device to device (D2D) as an air interface technique. In the V2X service, the speed of a vehicle is relatively high, and especially when two vehicles are moving towards each other, the relative speed is even higher, while application scenarios of D2D are all in low speeds. Therefore, how to improve accuracy of channel estimation in a D2D scenario employing V2X services has become one of studied subjects in the field.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In order to solve the above problem pointed out in the Background, embodiments of this disclosure provide a method and apparatus for transmitting demodulation reference signals and a system.

According to a first aspect of the embodiments of this disclosure, there is provided a method for transmitting demodulation reference signals, applicable to a long term evolution (LTE) communication system, the LTE communication system including first equipment and second equipment, the first equipment and the second equipment communicating via a sidelink, the method including:

transmitting additional demodulation reference signals (DMRSs) by the first equipment to the second equipment via the sidelink, the additional DMRSs being located in the last orthogonal frequency division multiplexing (OFDM) symbol of each subframe of the sidelink.

According to a second aspect of the embodiments of this disclosure, there is provided an apparatus for transmitting demodulation reference signals, applicable to first equipment in an LTE communication system, the LTE communication system further including second equipment, the first equipment and the second equipment communicating via a sidelink, the apparatus including:

a transmitting unit configured to transmit additional DMRSs to the second equipment via the sidelink, the additional DMRSs being located in the last OFDM symbol of each subframe of the sidelink.

According to a third aspect of the embodiments of this disclosure, there is provided UE, including the apparatus as described in the second aspect.

According to a fourth aspect of the embodiments of this disclosure, there is provided an LTE communication system, including first equipment and second equipment, the first equipment and the second equipment communicating via a sidelink, wherein,

the first equipment is configured to:

transmit normal DMRSs and additional DMRSs to the second equipment via the sidelink, the normal DMRSs being located in fourth and tenth OFDM symbols of each subframe of the sidelink or being located in third and ninth OFDM symbols of each subframe of the sidelink, and the additional DMRSs being located in the last OFDM symbol of each subframe of the sidelink;

and the second equipment is configured to:

receive, via the sidelink, the normal DMRSs and the additional DMRSs transmitted by the first equipment, so as to perform channel estimation according to the additional DMRSs and the normal DMRSs.

An advantage of the embodiments of this disclosure exists in that new DMRS sequences are proposed and are placed in the last symbol of a subframe of the sidelink of the LTE system for transmission, thereby enhancing original DMRSs, and improving accuracy of channel estimation.

With reference to the following description and drawings, the particular embodiments of this disclosure are disclosed in detail, and the principles of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the exemplary embodiments of the present disclosure, and are used for setting forth the principles of the present disclosure together with the description. It is clear and understood that the accompanying drawings in the following description are some embodiments of this disclosure, and for those of ordinary skills in the art, other accompanying drawings may be obtained according to these accompanying drawings without making an inventive effort. In the drawings:

FIG. 1 is a flowchart of a method for transmitting demodulation reference signals of an embodiment of this disclosure;

FIG. 2 is a schematic diagram of a structure of a sidelink subframe in a normal CP in prior art;

FIG. 3 is a schematic diagram of a structure of a sidelink subframe in a normal CP in an embodiment of this disclosure;

FIG. 4 is a schematic diagram of a structure of a sidelink subframe in an extended CP in prior art;

FIG. 5 is a schematic diagram of a structure of a sidelink subframe in an extended CP in an embodiment of this disclosure;

FIG. 6 is a schematic diagram of a structure of an apparatus for transmitting demodulation reference signals of an embodiment of this disclosure;

FIG. 7 is a schematic diagram of a structure of communication equipment of an embodiment of this disclosure; and

FIG. 8 is a schematic diagram of a topology of a communication system of an embodiment of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

Various embodiments of this disclosure shall be described below with reference to the accompanying drawings. These embodiments are illustrative only, and are not intended to limit this disclosure.

### EMBODIMENT 1

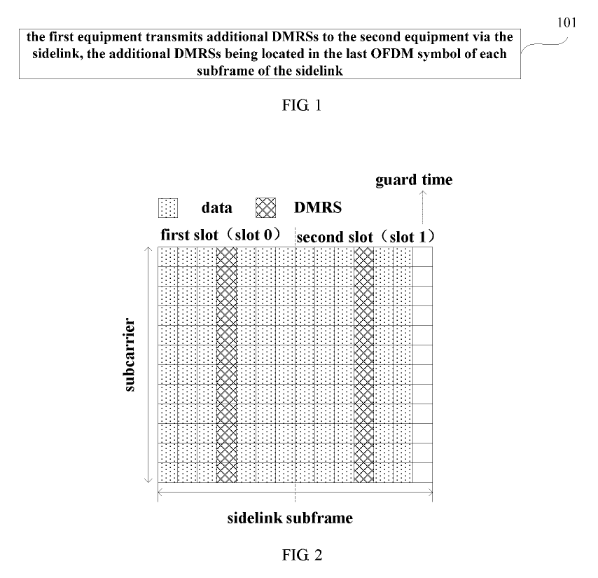

The embodiment provides a method for transmitting demodulation reference signals, applicable to an LTE communication system, the LTE communication system including first equipment and second equipment, the first equipment and the second equipment communicating via a sidelink, that is, the first equipment and the second equipment are in a device-to-device (D2D) communication mode. FIG. 1 is a flowchart of the method. Referring to FIG. 1, the method includes:

step 101: the first equipment transmits additional demodulation reference signals (DMRSs) to the second equipment via the sidelink, the additional DMRSs being located in the last orthogonal frequency division multiplexing (OFDM) symbol of each subframe of the sidelink.

Usually, being taken as guard time, the last symbol of a sidelink subframe of an LTE system does not transmit a signal. Taking a normal cyclic prefix (CP) as an example, each subframe has two slots, each slot having seven orthogonal frequency division multiplexing (OFDM) symbols, the last symbol being taken as guard time and not transmitting a signal, as shown in FIG. 2.

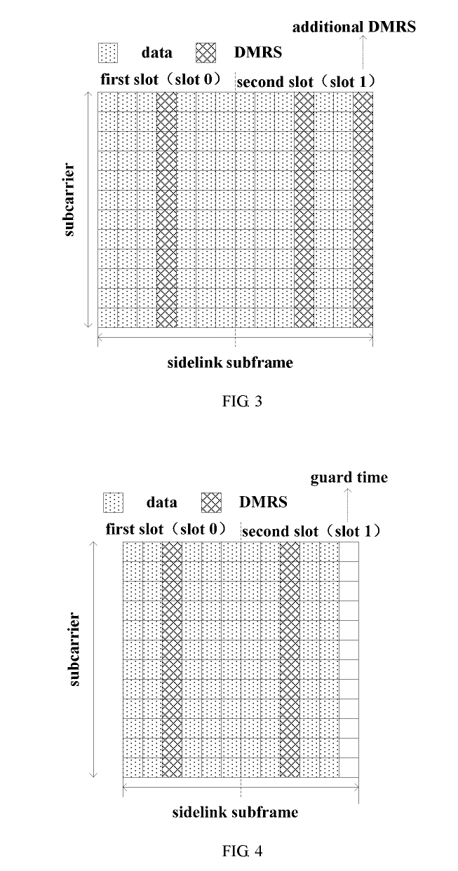

In this embodiment, new DMRS sequences are placed in the above guard time for transmission. As shown in FIG. 3, hence, such a pattern makes DMRSs denser in time domain, a minimum interval between reference signals being three symbols in time domain, while a previous minimum interval being seven symbols. It can be seen from digital signal processing knowledge that the range of frequency tracking is inversely proportional to the minimum interval of reference signals in time domain, and a severe Doppler frequency offset may be caused in a high-speed scenario. Such a frequency offset is proportional to the speed of a vehicle, hence, such a pattern is able to support a scenario of a higher speed.

Furthermore, moving at a high speed will make channel time selective attenuation more severe. In an original pattern, as shown in FIG. 2, each subcarrier within one subframe has only two reference points in time domain, and for channel estimation, if an interpolation method is employed, linear interpolation may only be used in the interpolation. In the pattern of this embodiment, as shown in FIG. 3, each subcarrier has three reference points within one subframe in time domain, and polynomial interpolation of higher orders may be performed, thereby obtaining a more accurate result of channel estimation. In this embodiment, performing the channel estimation by using the interpolation method is illustrative only, and this embodiment is not limited thereto. In particular implementations, other methods may also be used to perform channel estimation.

In this embodiment, the first equipment further transmits normal DMRSs, in addition to the additional DMRSs, to the second equipment via the sidelink, positions of the normal DMRSs being the same as those in prior art. Still taking the normal CP as an example, as shown in FIG. 3, the normal DMRSs are located in fourth and tenth OFDM symbols of each subframe of the sidelink. For the sake of description, the normal DMRSs in the normal CP are referred to as first normal DMRSs.

In this embodiment, the newly-proposed DMRSs may be any sequences known at receiver and transmitter ends (such as the above-described first equipment and second equipment). In one implementation, the sequence length of the newly-proposed DMRSs is identical to the sequence length of original DMRSs, that is, the sequence length of the additional DMRSs is identical to the sequence length of the normal DMRSs. Hence, understanding of the DMRSs by both the receiver and transmitter ends may be ensured consistent.

In this embodiment, the newly-proposed DMRSs may be completely identical to normal DMRSs in a first slot (slot 0) within the subframe (located in the fourth OFDM symbol of the subframe), and may also be completely identical to normal DMRSs in a second slot (slot 1) within the subframe (located in the tenth OFDM symbol of the subframe). Taking that the newly-proposed DMRSs are identical to the normal DMRSs in slot 1 within the subframe as an example, following contents may be added to an existing standard: sequence generation and mapping processes of the additional DMRSs shall be identical to those of the DMRSs in the slot 1, with the exception that for a normal CP, l=6, and for an extended CP, l=5, and the additional DMRSs are only transmitted in the slot 1. In the above description, l is a serial number of an OFDM symbol in a slot of a subframe, which is a non-negative integer counted from 0, and the value range of which is 0˜6 for a normal CP, and 0˜5 for an extended CP.

The method of this embodiment is described above by taking a normal CP as an example. And for an extended CP, its principle is similar to that of the normal CP, with exception of positions of the normal DMRSs.

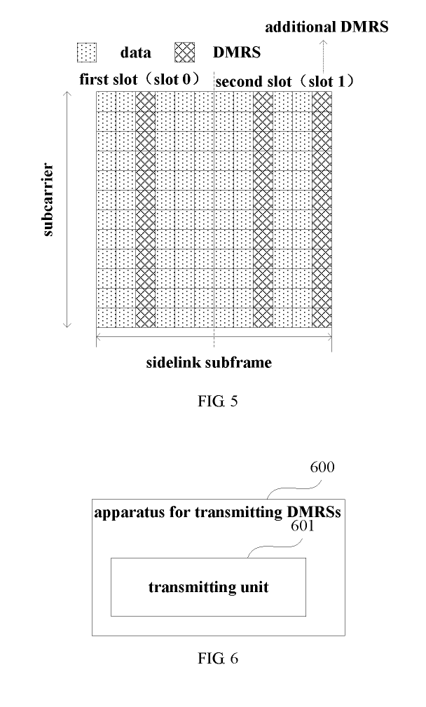

FIG. 4 is a schematic diagram of a structure of a sidelink subframe when an extended CP is employed by a subframe of a sidelink of LTE. As shown in FIG. 4, for the extended CP, each subframe has two slots, each slot having six OFDM symbols, the last symbol (a twelfth OFDM symbol) being taken as guard time and not transmitting a signal. The last symbol is used in this embodiment to transmit the above additional DMRSs, as shown in FIG. 5.

In this implementation, different from the normal CP, the normal DMRSs are located in a third OFDM symbol of each slot of the subframe, and as shown in FIG. 5, the normal DMRSs are located in the third OFDM symbol and a ninth OFDM symbol of each subframe of the sidelink. For the sake of description, the normal DMRSs in the extended CP are referred to as second normal DMRSs.

In this implementation, similar to the normal CP, the sequence length of the additional DMRSs may be identical to that of original DMRSs. For example, the sequence length of the additional DMRSs is identical to that of the DMRSs in the third OFDM symbol, or is identical to that of the DMRSs in the ninth OFDM symbol.

In this implementation, similar to the normal CP, the additional DMRSs may be completely identical to the original DMRSs. For example, the additional DMRSs are identical to the DMRSs in slot 0 (located in the third OFDM symbol), or are identical to the DMRSs in slot 1 (located in the ninth OFDM symbol).

In this embodiment, the first equipment and the second equipment may respectively be two pieces of UE performing D2D communication in an LTE system, may also be two eNBs in an LTE system, and may also be two vehicles in an LTE system, this embodiment is not limited thereto, and any two pieces of equipment may adopt the method of this embodiment, only if there exists a sidelink therebetween.

With the method of this embodiment, new DMRS sequences are proposed and are placed in the last symbol of a subframe of the sidelink of the LTE system for transmission, thereby enhancing original DMRSs, and improving accuracy of channel estimation.

### EMBODIMENT 2

The embodiment provides an apparatus for transmitting demodulation reference signals, applicable to first equipment in an LTE communication system, the LTE communication system further including second equipment, the first equipment and the second equipment communicating via a sidelink. As principles of the apparatus for solving problems are similar to that of the method of Embodiment 1, the implementation of the method of Embodiment 1 may be referred to for implementation of the apparatus, with identical contents being not going to be described herein any further.

FIG. 6 is a schematic diagram of a structure of the apparatus 600. As shown in FIG. 6, the apparatus includes:

a transmitting unit 601 configured to transmit additional DMRSs to the second equipment via the sidelink, the additional DMRSs being located in the last OFDM symbol of each subframe of the sidelink.

In one implementation of this embodiment, if a subframe of the sidelink employs a normal cyclic prefix (CP), the transmitting unit 601 further transmits first normal DMRSs to the second equipment via the sidelink, the first normal DMRSs being located in fourth and tenth OFDM symbols of each subframe of the sidelink.

In this implementation, the sequence length of the additional DMRSs is identical to the sequence length of the first normal DMRSs.

In this implementation, the sequence of the additional DMRSs is identical to the sequence of the first normal DMRSs located in the fourth or the tenth OFDM symbol.

In another implementation of this embodiment, if subframes of the sidelink employ an extended cyclic prefix (CP), the transmitting unit 601 further transmits second normal DMRSs to the second equipment via the sidelink, the second normal DMRSs being located in third and ninth OFDM symbols of each subframe of the sidelink.

In this implementation, the sequence length of the additional DMRSs is identical to the sequence length of the second normal DMRSs.

In this implementation, the sequence of the additional DMRSs is identical to the sequence of the second normal DMRSs located in the third or the ninth OFDM symbol.

With the apparatus of this embodiment, in communicating with other equipment, new DMRS sequences are proposed and are placed in the last symbol of a subframe of the sidelink of the LTE system for transmission, thereby enhancing original DMRSs, and improving accuracy of channel estimation.

### EMBODIMENT 3

The embodiment provides communication equipment in an LTE communication system, including the apparatus for transmitting demodulation reference signals described in Embodiment 2.

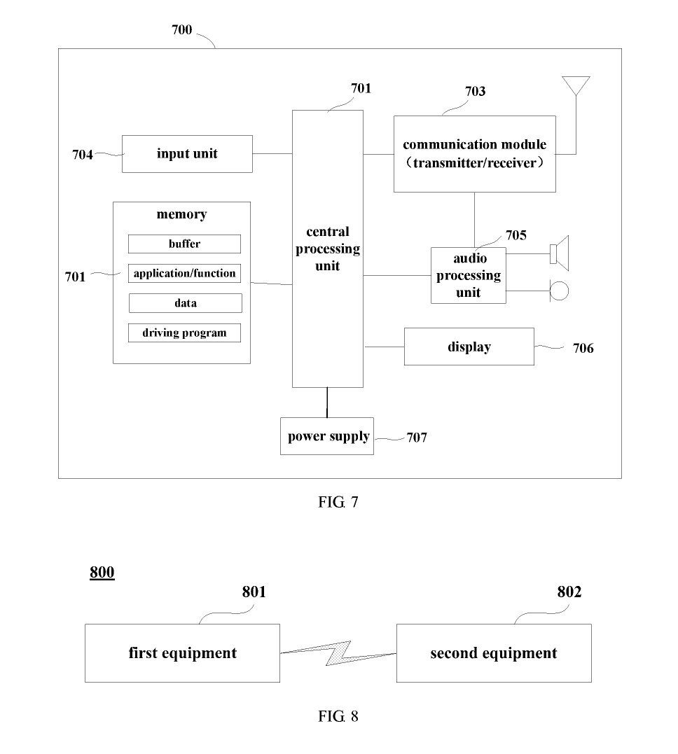

FIG. 7 is a schematic diagram of a structure of the communication equipment 700 of the embodiment of this disclosure. As shown in FIG. 7, the communication equipment 700 may include a central processing unit 701 and a memory 702, the memory 702 being coupled to the central processing unit 701. It should be noted that this figure is illustrative only, and other types of structures may also be used, so as to supplement or replace this structure and achieve a telecommunications function or other functions.

In one implementation, the functions of the apparatus for transmitting demodulation reference signals may be integrated into the central processing unit 701.

In another implementation, the apparatus for transmitting demodulation reference signals and the central processing unit 701 may be configured separately. For example, the apparatus for transmitting demodulation reference signals may be configured as a chip connected to the central processing unit 701, with its functions being realized under control of the central processing unit 701.

As shown in FIG. 7, the communication equipment 700 may further include a communication module 703, an input unit 704, an audio processing unit 705, a display 706 and a power supply 707. It should be noted that the communication equipment 700 does not necessarily include all the parts shown in FIG. 7, and furthermore, the communication equipment 700 may include parts not shown in FIG. 7, and the prior art may be referred to.

As shown in FIG. 7, the central processing unit 701 is sometimes referred to as a controller or control, and may include a microprocessor or other processor devices and/or logic devices. The central processing unit 701 receives input and controls operations of every components of the communication equipment 700.

In this embodiment, the memory 702 may be, for example, one or more of a buffer memory, a flash memory, a hard drive, a mobile medium, a volatile memory, a nonvolatile memory, or other suitable devices, which may store the above information, and may further store a program executing related information. And the central processing unit 701 may execute the program stored in the memory 702, so as to realize information storage or processing, etc. Functions of other parts are similar to those of the prior art, which shall not be described herein any further. The parts of the communication equipment 700 may be realized by specific hardware, firmware, software, or any combination thereof, without departing from the scope of the present disclosure.

With the communication equipment of this embodiment, in communicating with other equipment via the sidelink, new DMRS sequences are proposed and are placed in the last symbol of a subframe of the sidelink of the LTE system for transmission, thereby enhancing original DMRSs, and improving accuracy of channel estimation.

### EMBODIMENT 4

The embodiment further provides a communication system. FIG. 8 is a schematic diagram of a structure of an implementation of the communication system. As shown in FIG. 8, the communication system 800 includes first equipment 801 and second equipment 802, the first equipment 801 and the second equipment 802 communicating via a sidelink.

In this embodiment, the first equipment 801 is configured to: transmit normal DMRSs and additional DMRSs to the second equipment via the sidelink, the normal DMRSs being located in fourth and tenth OFDM symbols of each subframe of the sidelink or being located in third and ninth OFDM symbols of each subframe of the sidelink, and the additional DMRSs being located in the last OFDM symbol of the subframe of the sidelink.

In this embodiment, the second equipment 802 is configured to: receive, via the sidelink, the normal DMRSs and the additional DMRSs transmitted by the first equipment 801, so as to perform channel estimation according to the additional DMRSs and the normal DMRSs.

In this embodiment, the sequence length of the additional DMRSs is identical to the sequence length of the normal DMRSs.

In this embodiment, the sequence of the additional DMRSs is identical to the sequence of the normal DMRSs.

With the communication system of this embodiment, when the first equipment communicates with the second equipment via the sidelink, new DMRS sequences are proposed and are placed in the last symbol of a subframe of the sidelink of the LTE system for transmission, thereby enhancing original DMRSs, and improving accuracy of channel estimation.

An embodiment of the present disclosure further provides a computer readable program code, which, when executed in an apparatus for transmitting demodulation reference signals or communication equipment, will cause a computer unit to carry out the method for transmitting demodulation reference signals described in Embodiment 1 in the apparatus for transmitting demodulation reference signals or the communication equipment.

An embodiment of the present disclosure further provides a computer readable medium, including a computer readable program code, which will cause a computer unit to carry out the method for transmitting demodulation reference signals described in Embodiment 1 in an apparatus for transmitting demodulation reference signals or communication equipment.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principles of the present disclosure, and such variants and modifications fall within the scope of the present disclosure.

What is claimed is:

1. A method for transmitting demodulation reference signals, applicable to a long term evolution (LTE) communication system, the LTE communication system comprising first equipment and second equipment, the first equipment and the second equipment communicating via a sidelink, the method comprising:
transmitting additional demodulation reference signals (DMRSs) by the first equipment to the second equipment via the sidelink, the additional DMRSs being located in the last orthogonal frequency division multiplexing (OFDM) symbol of each subframe of the sidelink.

2. The method according to claim 1, wherein if subframes of the sidelink employ a normal cyclic prefix (CP), the first equipment further transmits first normal DMRSs to the second equipment via the sidelink, the first normal DMRSs being located in fourth and tenth OFDM symbols of each subframe of the sidelink.

3. The method according to claim 2, wherein the sequence length of the additional DMRSs is identical to the sequence length of the first normal DMRSs.

4. The method according to claim 2, wherein the sequence of the additional DMRSs is identical to the sequence of the first normal DMRSs located in the fourth or the tenth OFDM symbol.

5. The method according to claim 1, wherein if subframes of the sidelink employ an extended cyclic prefix (CP), the first equipment further transmits second normal DMRSs to the second equipment via the sidelink, the second normal DMRSs being located in third and ninth OFDM symbols of each subframe of the sidelink.

6. The method according to claim 5, wherein the sequence length of the additional DMRSs is identical to the sequence length of the second normal DMRSs.

7. The method according to claim 5, wherein the sequence of the additional DMRSs is identical to the sequence of the second normal DMRSs located in the third or the ninth OFDM symbol.

8. An apparatus for transmitting demodulation reference signals, applicable to first equipment in an LTE communication system, the LTE communication system further comprising second equipment, the first equipment and the second equipment communicating via a sidelink, the apparatus comprising:
a transmitting unit configured to transmit additional DMRSs to the second equipment via the sidelink, the additional DMRSs being located in the last OFDM symbol of each subframe of the sidelink.

9. The apparatus according to claim 8, wherein if subframes of the sidelink employ a normal cyclic prefix (CP), the transmitting unit further transmits first normal DMRSs to the second equipment via the sidelink, the first normal DMRSs being located in fourth and tenth OFDM symbols of each subframe of the sidelink.

10. The apparatus according to claim 9, wherein the sequence length of the additional DMRSs is identical to the sequence length of the first normal DMRSs.

11. The apparatus according to claim 9, wherein the sequence of the additional DMRSs is identical to the sequence of the first normal DMRSs located in the fourth or the tenth OFDM symbol.

12. The apparatus according to claim 8, wherein if subframes of the sidelink employ an extended cyclic prefix (CP), the transmitting unit further transmits second normal DMRSs to the second equipment via the sidelink, the second normal DMRSs being located in third and ninth OFDM symbols of each subframe of the sidelink.

13. The apparatus according to claim 12, wherein the sequence length of the additional DMRSs is identical to the sequence length of the second normal DMRSs.

14. The apparatus according to claim 12, wherein the sequence of the additional DMRSs is identical to the sequence of the second normal DMRSs located in the third or the ninth OFDM symbol.

15. An LTE communication system, comprising first equipment and second equipment, the first equipment and the second equipment communicating via a sidelink, wherein,
the first equipment is configured to:
transmit normal DMRSs and additional DMRSs to the second equipment via the sidelink, the normal DMRSs being located in fourth and tenth OFDM symbols of each subframe of the sidelink or being located in third and ninth OFDM symbols of each subframe of the sidelink, and the additional DMRSs being located in the last OFDM symbol of the subframe of the sidelink;
and the second equipment is configured to:
receive, via the sidelink, the normal DMRSs and the additional DMRSs transmitted by the first equipment, so as to perform channel estimation according to the additional DMRSs and the normal DMRSs.

16. The system according to claim 15, wherein the sequence length of the additional DMRSs is identical to the sequence length of the normal DMRSs.

17. The system according to claim 15, wherein the sequence of the additional DMRSs is identical to the sequence of the normal DMRSs.
